(19) United States
(12) Patent Application Publication
(10) Pub. No.: US 2026/0203624 A1
(43) Pub. Date: Jul. 16, 2026

(54) Method for Processing a Quantum Sensor Signal

(71) Applicant: Siemens Aktiengesellschaft, München (DE)

(72) Inventors: Oliver von Sicard, München (DE); Christoph Niedermeier, München (DE); Wolfgang Mauerer, Donaustauf (DE); Karen Wintersperger, München (DE)

(73) Assignee: Siemens Aktiengesellschaft, München (DE)

(21) Appl. No.: 18/861,514

(22) PCT Filed: Apr. 14, 2023
(86) PCT No.: PCT/EP2023/059764

§ 371 Date: Oct. 29, 2024

(30) Foreign Application Priority Data
Apr. 29, 2022 (DE) 10 2022 204 234.4
Aug. 4, 2022 (EP) 22188793.8

(51) Int. Cl. G06N 10/40

(52) U.S. Cl. CPC G06N 10/40

(57) ABSTRACT

Various embodiments of the teachings herein include methods for processing a quantum sensor signal of a quantum sensor. An example includes: obtaining a quantum sensor signal including a quantum-physical superposition state with the quantum sensor; and processing the superposition state without prior reduction with quantum information processing.

### CROSS-REFERENCE TO RELATED APPLICATIONS

This application is a U.S. National Stage Application of International Application No. PCT/EP2023/059764 filed Apr. 14, 2023, which designates the United States of America, and claims priority to EP Application No. 22188793.8 filed Aug. 4, 2022 and DE Application No. 10 2022 204 234.4 filed Apr. 29, 2022, the contents of which are hereby incorporated by reference in their entirety.

### TECHNICAL FIELD

The present disclosure relates to quantum n sensors. Various embodiments of the teachings herein systems and/or methods for processing a quantum sensor signal from a quantum sensor.

### BACKGROUND

Measurement analysis systems comprising quantum sensors using specific properties of quantum systems, such as entanglement or interference, to achieve a higher level of precision than is possible with conventional classical sensors. Such quantum sensors are may be used in the detection of external physical variables, in particular of electrical or magnetic fields, wherein the sensitivity of quantum states to environmental influences is utilized.

In this case, a superposition state of the quantum sensor is used and an influence of the superposition state is used to deduce the external physical variable. The superposition state of the quantum sensor may be reduced during a measurement and the external physical variable is able to be deduced.

### SUMMARY

The teachings of the present disclosure include methods for processing a quantum sensor signal from a quantum sensor and measurement analysis systems comprising a quantum sensor. Various embodiments of the teachings herein include a method for processing a quantum sensor signal (SG) of at least one quantum sensor (QSENS), in which at least one quantum sensor signal (SG) in the form of at least one quantum-physical superposition state (QS) is obtained by means of the at least one quantum sensor (QSENS), and said at least one superposition state (QS) is processed without prior reduction by means of quantum information processing.

In some embodiments, the quantum information processing comprises a data analysis, in particular quantum machine learning and/or quantum image processing.

In some embodiments, the quantum information processing does not stop at a detection by means of the at least one quantum sensor (QSENS).

In some embodiments, the quantum information processing comprises the use of quantum-logic operations, in particular the use of quantum-logic gates and/or a quantum Fourier transform.

In some embodiments, the quantum-logic operations utilize at least one universal set of quantum gates, preferably use each quantum gate of the universal set at least once or several times.

In some embodiments, the superposition state (QS) of the quantum sensor signal (SG) is stored, in particular in at least one quantum register in the form of a quantum memory.

As another example, some embodiments include a measurement analysis system comprising at least one quantum sensor (QSENS), in particular designed to carry out a method as described herein wherein the quantum sensor (QSENS) is set up to provide at least one quantum sensor signal (SG) in the form of a quantum-physical superposition state (QS), and comprising a quantum computer (QC) that has a quantum register and a quantum-logic device (QDA) for quantum information processing of the quantum register, wherein, in the measurement analysis system, the at least one quantum sensor signal in the form of the superposition state is able to be transferred to at least one superposition state (QSR) of the quantum register without prior reduction or forms the superposition state of the quantum register.

In some embodiments, the quantum register is a quantum memory.

In some embodiments, the quantum sensor signal (SG) is able to be transferred by means of a state transfer and/or by means of a particle transfer and/or by means of a quasi-particle transfer and/or by means of a field transfer and/or by means of an ion-trap transfer and/or by means of a crystal defect transfer.

In some embodiments, the quantum information processing comprises a data analysis, in particular quantum machine learning and/or quantum image processing.

In some embodiments, the quantum information processing does not stop at a detection by means of the quantum sensor (QSENS).

In some embodiments, the quantum-logic device (QDA) comprises an arrangement and/or a sequence of quantum-logic gates and/or an arrangement for performing a quantum Fourier transform.

In some embodiments, the quantum-logic device is able to be configured to form each quantum gate of at least one universal set of quantum gates.

In some embodiments, the quantum-logic device includes each quantum gate of a universal set of quantum gates.

As another example, some embodiments include a magnetic resonance tomograph and/or manufacturing apparatus and/or maintenance apparatus, set up to carry out a method as described herein and/or comprising a measurement analysis system (DETCOMPU) as described herein.

### BRIEF DESCRIPTION OF THE DRAWINGS

The teachings of the present disclosure are explained in more detail below using an exemplary embodiment illustrated in the drawing, in which:

FIG. 1 schematically shows a basic diagram of a conventional measurement analysis system comprising a quantum sensor for conventional information processing of a quantum sensor signal from the quantum sensor; and

FIG. 2 schematically shows a basic diagram of a quantum measurement analysis system incorporating teachings of the present disclosure comprising a quantum sensor and a quantum computer for carrying out the methods for processing a quantum sensor signal from the quantum sensor.

### DETAILED DESCRIPTION

In the methods described herein for processing at least one quantum sensor signal from at least one quantum sensor, at least one quantum sensor signal in the form of at least one quantum-physical superposition state is obtained by means of the at least one quantum sensor, and said at least one superposition state is processed without prior reduction by means of quantum information processing.

A quantum sensor signal from the at least one quantum sensor is therefore not, as has previously been conventional, initially measured and therefore reduced, but rather the at least one quantum sensor signal is maintained as a quantum-physical superposition state and is made available without intermediate measurement, that is to say without prior reduction of the quantum-physical superposition state by the quantum information processing. The methods described herein may therefore be used to utilize specific quantum properties, such as the relative phase information of a superposition state or the entanglement of the at least one superposition state, for instance the entanglement of a plurality of qubits of the at least one quantum sensor signal, for processing quantum information.

Not only is improved detection by means of the at least one quantum sensor possible, but at the same time, improved quantum information processing of the at least one quantum sensor signal is also therefore possible using the methods described herein. As a result, data is able to be evaluated more quickly and in a qualitatively improved manner. quantum-assisted analysis methods may be utilized directly in the quantum information processing. This is because such quantum-assisted analysis methods regularly require input data in the form of at least one quantum-physical superposition state, which, in the method according to the invention, is advantageously already available in the form of the at least one quantum sensor signal from the at least one quantum sensor. Complex encoding of a classical signal into a quantum-physical superposition state is therefore advantageously dispensable in the method according to the invention.

It goes without saying that such a quantum sensor used in the context of the method according to the invention is preferably designed in such a way that an external physical variable, that is to say a variable that does not characterize the quantum sensor or the superposition state of the quantum sensor, is able to be measured by means of the superposition state. The quantum sensor is therefore designed and set up in such a way that the quantum sensor is therefore not primarily configured to measure the state of the quantum sensor itself, but rather to provide a superposition state that, owing to a reduction of this superposition state, allows the external physical variable, that is to say the measured variable of the quantum sensor, to be able to be measured.

In some embodiments, the external physical variable is not to be understood to be an unintended noise influence. Rather, the quantum sensor may be set up to be coupled to the external physical variable that is intended to be captured using the quantum sensor and/or particularly isolated, in particular shielded, to prevent an influence of variables that are not identical to the external physical variable.

A quantum sensor provides a quantum sensor signal dependent on the external physical variable. In contrast, an evaluation circuit that evaluates the quantum sensor signal by means of reducing the quantum-physical superposition state and, together with the quantum sensor, forms a measuring device is not or at least not necessarily part of the quantum sensor used according to the invention. Expediently, the quantum sensor is particularly designed and set up, in particular configured, to capture the external physical variable.

Expediently, the quantum-physical superposition states are implemented by means of qubits. The qubits may be formed with ion traps, crystal defects, in particular in diamond crystals, and/or are in the form of superconducting qubits.

In some embodiments, the quantum information processing comprises a data analysis, in particular quantum machine learning and/or quantum image processing. In this way, quantum sensor signals could easily be analyzed by means of quantum-assisted data analyses. In particular, quantum sensor signals may be made available to evaluation methods such as quantum machine learning and/or quantum image processing in a very direct way, with the result that complex evaluation methods that have not been available hitherto or are available only with difficulty are now available for quantum sensors.

In some embodiments, the quantum information processing does not stop at a detection by means of the at least one quantum sensor. The quantum information processing is therefore actual quantum-logic quantum information processing in the narrow sense, that is to say quantum information processing by means of quantum-logic processes.

In some embodiments, the quantum information processing comprises the use of quantum-logic operations, in particular the use of quantum-logic gates and/or a quantum Fourier transform. In some embodiments, the quantum-logic operations utilize at least one universal set of quantum gates, that is to say that the quantum information processing uses each quantum gate of the universal set at least once.

In some embodiments, the at least one superposition state of the at least one quantum sensor signal is stored, in particular in at least one quantum register in the form of a quantum memory. The quantum sensor signals do not have to be kept available by the at least one quantum sensor until the quantum sensor signals are further processed by means of quantum information processing. Instead, quantum sensor signals may be stored so that the at least one quantum sensor may already be available to capture new quantum sensor signals. The capture rate of the at least one quantum sensor is therefore independent of the use of the quantum sensor signals for the quantum information processing and may not be limited.

In some embodiments, the quantum information processing is carried out by means of two-state systems or multi-state systems that are different from the two-state systems or multi-state systems that are used by the quantum sensor to implement its quantum sensor signals. Different architectures, in particular different hardware architectures, are therefore used for the quantum sensor and for the quantum information processing.

The measurement analysis system has at least one quantum sensor set up to provide at least one quantum sensor signal in the form of a quantum-physical superposition state, and a quantum computer comprising a quantum register and a quantum-logic device for quantum information processing of the quantum register. In the measurement analysis system, the at least one quantum sensor signal in the form of the superposition state is able to be transferred to a superposition state of the quantum register without prior reduction of the quantum sensor signal forms the superposition state of the quantum register without prior reduction.

A classical measurement signal from the at least one quantum sensor is therefore not, as has previously been conventional, obtained and subsequently the classical measurement signal encoded into a quantum-physical superposition state, which is then in turn transmitted to the quantum-logic device. Instead, quantum information processing of the at least one quantum sensor signal may be carried out directly, that is to say without prior reduction of the quantum sensor signal that is in the superposition state. The measurement analysis system incorporating teachings of the present disclosure therefore makes it possible to carry out the methods, as described herein, in a simple manner. The measurement analysis system accordingly has the advantages already described with respect to the methods described herein.

In some embodiments, the quantum register is a quantum memory. The states of the quantum sensor may be buffer-stored by the quantum memory, in particular a QRAM, with the result that the at least one quantum sensor does not have to maintain the quantum sensor state until the quantum-logic device processes the quantum sensor signal. Instead, the at least one quantum sensor may be put back into a measurement-ready operating state, with the result that a high data rate may be achieved by means of the at least one quantum sensor. The operation of the at least one quantum sensor is therefore not limited by the reduction of the at least one quantum sensor signal by the quantum-logic device, but rather a plurality of quantum sensor signals may also be captured successively and be supplied to the quantum-logic device together by means of a plurality of quantum registers in the form of quantum memories. In this development, complex quantum-logic methods for quantum information processing are therefore also able to be implemented in the measurement analysis system incorporating teachings of the present disclosure.

In some embodiments, the at least one quantum sensor signal is able to be transferred by means of a state transfer and/or by means of a qubit transfer, in particular by means of a particle transfer and/or by means of a quasi-particle transfer and/or by means of a field transfer or by means of a transfer of crystal defects or by means of a transfer of one or more ion traps or by means of an interaction between the quantum sensor signal and the quantum register. In this way, the quantum sensor signal or the superposition state of the quantum sensor signal is easily able to be supplied to the quantum-logic device for further quantum information processing.

In some embodiments, the quantum information processing comprises a data analysis, in particular quantum machine learning and/or quantum image processing. In particular in the case of quantum machine learning and/or quantum image processing, the advantage of the direct quantum information processing of a quantum-physical superposition state provided by the quantum sensor, is able to be easily achieved.

In some embodiments, the quantum information processing does not stop at a detection by means of the at least one quantum sensor signal, that is to say that the quantum information processing is actually not just an improved determination of the measured variable captured by means of the at least one quantum sensor. Instead, in this development, the at least one quantum sensor signal is processed in such a way that a processing result of the quantum information processing goes beyond a merely improved detection by means of the at least one quantum sensor signal. The at least one quantum sensor signal is therefore particularly preferably linked to further variables or signals to form a new item of information.

The quantum-logic device comprises an arrangement and/or a sequence of quantum-logic gates and/or an arrangement for performing a quantum Fourier transform. Complex quantum information processing algorithms are therefore available.

In some embodiments, the quantum-logic device is able to be configured to form each quantum gate of at least one universal set of quantum gates, that is to say that the quantum-logic device may be configured to use, at least once, each quantum gate of the universal set. The quantum-logic device of the measurement analysis system is expediently set up to be able to be configured to use each quantum gate of the universal set. In this way, a plurality of different, in principle arbitrary, in particular arbitrarily complex, quantum information processing algorithms are able to be implemented using one or more of the measurement analysis systems described herein.

In some embodiments, the quantum-logic device includes each quantum gate of a universal set of quantum gates, for instance of the universal set as described in the previous development or of a universal set that is different therefrom, at least once. Sufficiently complex quantum information processing algorithms may therefore be implemented in the quantum-logic device.

In some embodiments, the quantum register and/or the quantum-logic device comprise or comprises two-state systems or multi-state systems that are different from the two-state systems or multi-state systems that are used by the quantum sensor to provide the quantum sensor signal. Different architectures, in particular different hardware architectures, are therefore used for the quantum sensor and for the quantum computer.

The magnetic resonance tomograph and/or the manufacturing apparatus and/or the maintenance apparatus and/or the logistics apparatus are/is in each case set up to carry out a method, as described above, and/or have/has a measurement analysis system, as described above.

In the case of a magnetic resonance tomograph according to the invention, the quantum-logic device may be formed for the quantum information processing of magnetic resonance signals. In contrast, in the manufacturing apparatus, the quantum-logic device may be formed for the quantum information processing of manufacturing signals, in particular feedback signals that arise during manufacturing and may be used to adapt the manufacturing process. In the case of a maintenance apparatus, the quantum-logic device is designed for the quantum information processing of maintenance signals, for instance maintenance signals relating to the state of an object that is to be maintained. In the case of a logistics device, the quantum-logic device may be designed for the quantum information processing of logistics signals.

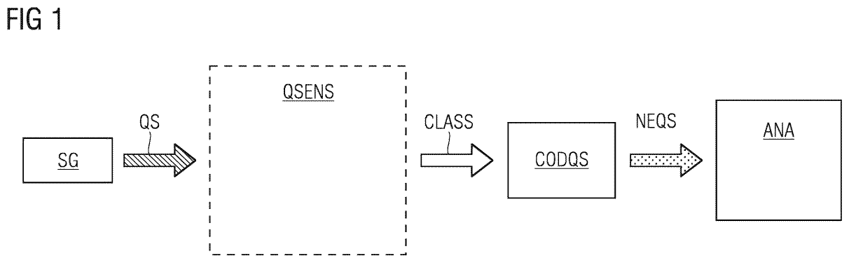

The measurement analysis system shown in FIG. 1 uses a quantum sensor QSENS to measure a quantum sensor signal. In the exemplary embodiment shown, the quantum sensor QSENS is a quantum sensor QSENS of a magnetic resonance tomograph incorporating teachings of the present disclosure. The quantum sensor QSENS is a magnetic field sensor that measures the precession frequency of atomic nuclei in external magnetic fields by means of quantum measurements. To this end, quantum sensor signals SG are obtained in a manner known per se from the measurement object, in the exemplary embodiment shown a tissue sample.

These quantum sensor signals SG are in this case quantum sensor signals SG in the form of quantum-physical superposition states that are used by the quantum sensor QSENS to increase the measurement accuracy. The quantum sensor signals SG from the measurement object therefore form non-classical states that are also referred to below as quantum states QS for short.

In order to evaluate the information obtained by the quantum sensor, the quantum state QS obtained by the quantum sensor QSENS in each case is reduced to form a classical state by means of a measurement process. That is to say that the quantum state QS captured by the quantum sensor QSENS is not maintained, but rather irreversibly reduced to form a classical state CLASS.

The classical state CLASS may then be subsequently evaluated, for instance by means of a quantum computer. To this end, the classical state CLASS is encoded into a new quantum state NEQS by means of an encoding process CODQS and provided to the quantum computer. The quantum computer carries out an analysis ANA in order to evaluate the classical states CLASS provided by the quantum sensor QSENS by means of quantum information processing. In the exemplary embodiment shown, the analysis comprises quantum image evaluation, which is also known as quantum image processing.

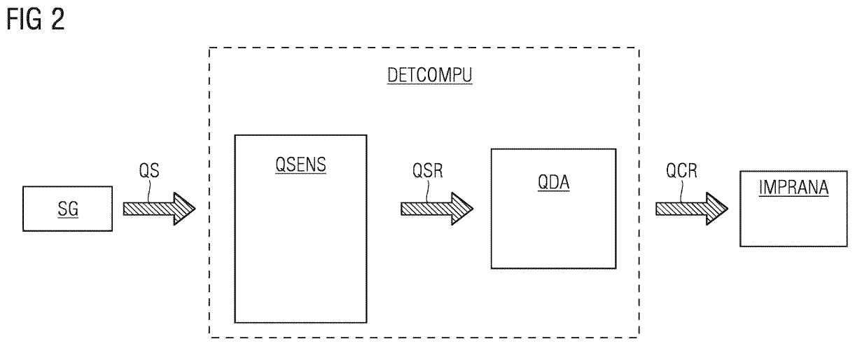

In contrast thereto, in the quantum measurement analysis system incorporating teachings of the present disclosure, shown in FIG. 2, the complete information regarding the quantum-physical superposition state QS is used by means of the method incorporating teachings of the present disclosure for processing a quantum sensor signal from a quantum sensor.

The quantum measurement analysis system shown in FIG. 2 is also used to measure and process quantum sensor signals SG from a magnetic resonance tomograph. As in the measurement analysis system that is shown in FIG. 1, one or more quantum sensors of a magnetic resonance tomograph are present in the integrated detection and processing unit DETCOMPU of drawing FIG. 2, said quantum sensors measuring the precession frequency of atomic nuclei in external magnetic fields and using quantum sensor signals SG in the form of quantum-physical superposition states for this purpose. The quantum sensor signals SG also form quantum states Qs in the exemplary embodiment shown in FIG. 2.

In contrast to the measurement analysis system shown in FIG. 1, however, in the integrated detection and processing unit DETCOMPU of FIG. 2, the quantum state QS is not initially reduced by means of a measurement and subsequently subjected to information processing, but rather the quantum State QS is initially transmitted to a quantum register of qubits. In this case, the quantum state QS is transmitted to the quantum register in such a way that the qubits of the quantum register are in a superposition state of qubit states. This quantum register (not shown explicitly in the drawing) is therefore in such a quantum register state QRS, which corresponds to the original quantum state QS in terms of its information content. This may either take place very directly by way of a transfer of the qubits themselves or, as in the case shown in FIG. 2, by means of an interaction between the quantum sensor signal from the quantum sensor QS and the quantum register. The original quantum state QS itself is destroyed when transmitted to the quantum register in the exemplary embodiment shown.

The quantum register then stores the quantum register state QSR and therefore forms a quantum memory in the form of a QRAM, with the result that the quantum sensor QSENS may conduct further quantum measurements.

The quantum register may be temporarily connected to a quantum circuit of the detection and processing unit DETCOMPU. If the quantum register is connected to the quantum circuit of the detection and processing unit, the quantum register state QSR of the quantum register, as quantum-physical superposition state, passes through a quantum-logic arrangement QDA comprising a multiplicity of quantum-logic gates, by means of which quantum information processing of the quantum register state QSR is carried out. The individual quantum-logic gates form a quantum-logic algorithm that, inter alia, includes a quantum Fourier transform. In some embodiments, the quantum circuit of the detection and processing unit DETCOMPU is able to be configured to form each quantum gate of at least one universal set of quantum gates or the quantum circuit includes each quantum gate of a universal set of quantum gates.

For an intermediate result of the quantum information processing of the quantum register state QSR, an output quantum register is provided, in which output qubits assume a quantum-physical output quantum register state QCR that is implemented as a quantum-physical superposition of output qubit states. A final result of the quantum information processing may be obtained by means of this output qubit, for instance by way of repetitive measurements of successive output qubit states and by means of further quantum-logic operations IMPRANA and subsequent measurements. The quantum-logic algorithm and the further quantum-logic operations IMPRANA are performed on the output quantum register state QCR for this purpose.

In some embodiments, the quantum measurement analysis system is not a magnetic resonance tomograph, but rather a manufacturing apparatus and, instead of a tissue sample, a measurement object in the form of a workpiece is measured. In some embodiments, the measurement analysis system is a maintenance apparatus and the measurement object is a workpiece or the measurement analysis system is a logistics device. In some embodiments, the quantum register and quantum circuit of the detection and processing unit DETCOMPU comprise two-state systems or multi-state systems that are different from the two-state systems or multi-state systems that are used by the quantum sensor QSENS to provide the quantum Sensor signal.

What is claimed is:

1. A method for processing a quantum sensor signal of a quantum sensor, the method comprising:
obtaining a quantum sensor signal including a quantum-physical superposition state with the quantum sensor; and
processing the superposition state without prior reduction with quantum information processing.

2. The method as claimed in claim 1, wherein quantum information processing comprises data analysis.

3. The method as claimed in claim 1, wherein the quantum information processing does not stop at a detection by the quantum sensor.

4. The method as claimed in claim 1, wherein quantum information processing comprises quantum-logic operations.

5. The method as claimed in claim 1, wherein the quantum-logic operations utilize a universal set of quantum gates.

6. The method as claimed in claim 1, further comprising storing the superposition state of the quantum sensor signal.

7. A measurement analysis system comprising:
a quantum sensor to provide a quantum sensor signal including a quantum-physical superposition state;
a quantum computer having a quantum register and a quantum-logic device for quantum information processing of the quantum register;
wherein the quantum sensor signal is transferred to a superposition state of the quantum register without prior reduction or forms the superposition state of the quantum register.

8. The measurement analysis system as claimed in claim 7, wherein the quantum register comprises a quantum memory.

9. The measurement analysis system as claimed in claim 7, wherein the quantum sensor signal is transferred using a state transfer, a particle transfer, a quasi-particle transfer, a field transfer, an ion-trap transfer, and/or a crystal defect transfer.

10. The measurement analysis system as claimed in claim 7, wherein the quantum information processing comprises a data analysis.

11. The measurement analysis system as claimed in claim 7, wherein the quantum information processing does not stop at a detection by means of the quantum sensor.

12. The measurement analysis system as claimed in claim 7, wherein the quantum-logic device comprises an arrangement, a sequence of quantum-logic gates, and/or an arrangement for performing a quantum Fourier transform.

13. The measurement analysis system as claimed in claim 7, wherein the quantum-logic device can be configured to form each quantum gate of a universal set of quantum gates.

14. The measurement analysis system as claimed in claim 7, wherein the quantum-logic device includes each quantum gate of a universal set of quantum gates.

15. (canceled)
